(19) United States
(12) Patent Application Publication
(10) Pub. No.: US 2016/0375648 A1
(43) Pub. Date: Dec. 29, 2016

(54) Structural panel insert having encapsulated filler materials

(71) Applicants: Richard Adams, Bolton, MA (US); James Sorensen, Eagan, MN (US)

(72) Inventors: Richard Adams, Bolton, MA (US); James Sorensen, Eagan, MN (US)

(21) Appl. No.: 14/545,835

(22) Filed: Jun. 26, 2015

(51) Int. Cl. B32B 3/12; B32B 15/20

(52) U.S. Cl. CPC B32B 3/12; B32B 15/20; B32B 2250/03; B32B 2260/04; B32B 2305/024; B32B 2307/50; B32B 2307/542; B32B 2571/02

(57) ABSTRACT

A structural insert according to the present invention can be utilized in a Metal Matrix Composite (MMC) structure such as an armor structure having one or more material layers with each material layer having at least one structural insert arranged along a common surface. Utilizing a polygonal or HoneyComb Core, a reinforcement material containing a fraction of high volume hollow microspheres with interior voids can be utilized and placed within the inserts cellular structure to decrease the weight of the armor system. Subsequent to metal infiltration, the metal encapsulates the micro-spheres within the cells of the cellular structure, forming pockets of micro-spheres therein. These encapsulated hollow microspheres comprise a ceramic or glass wall around an interior void having a wall thickness that reinforces the void wall surface. The encapsulating metal further bonds to the walls of the cellular structure increasing the crush strength of the cell wall. In one embodiment, having the entire cellular structure filled with micro-spheres, the combination of microsphere diameter, face-sheet type and thickness, and core thickness, combined with the increased bonding effect of the encapsulated spheres to the cell walls, has demonstrated superior energy absorption characteristics.

### FIELD OF THE INVENTION

This invention relates to inserts for structural panels in general and more specifically to a structural insert for Metal Matrix Composite (MMC) Armor, the insert having a cellular structure with openings having encapsulated filler materials bonded therein.

### BACKGROUND OF THE INVENTION

Many different kinds of lightweight armor systems are known and are currently being used in a wide range of applications, including, for example, aircraft, light armored vehicles, and body armor systems, wherein it is desirable to provide protection against bullets and other projectiles.

While early armor systems tended to rely on a single layer of material, it was soon realized that the effectiveness of the armor system could be improved considerably by using more than one material layer; each layer optimized for a specific purpose. For example, utilizing a hard monolithic ceramic face to initiate destruction of hardened projectiles and a backing layer of energy absorbing material such as high strength Ceramic fibers.

However, Ceramic and other polymer composites have poor strength in the through-the-thickness direction and they are not as rigid or stiff as metal backings. But metal backings have the problem of increased weight due to their higher density.

It has been discovered by the present inventors that a metal or metal matrix composite (MMC) backing, with lower density than an equivalent metal backing can be made by including a lightweight metal insert with cellular openings. Further, the openings can be filled with low density ceramic microspheres prior to infiltrating with aluminum.

It has been discovered that the use of an insert having a cellular structure filled with energy absorbing materials, such as high volume hollow micro-spheres functions to attenuate a blast from an explosive charge hit by deforming in response to the blast shock. It has been further discovered that the size of the hollow microspheres has a direct effect on the dynamic response of the core material. And further, that optimum energy absorption of the structural panel insert is achieved with a unique combination of microsphere diameter, face-sheet type and thickness, and core thickness. The hollow micro-spheres in combination with the cellular structure give unique ability to absorb and deflect the blast force thus breaking up the attendant stress waves. Most materials either crush or transmit blast wave energy, yet the subject of this invention has the characteristics uniquely suitable for energy absorption from a high strain rate blast event.

Subsequent to metal infiltration, the metal encapsulates the micro-spheres within the cells of the cellular structure, forming pockets of micro-spheres therein. The encapsulating metal further bonds to the walls of the cellular structure increasing the crush strength of the cell wall. Furthermore, the cellular structure can be placed in a variety of locations throughout the structural insert to achieve desired shear strength or density variations where needed.

Although honeycomb structures are prevalent in the prior art, a structural insert integrally cast in a Metal Matrix Composite (MMC) having encapsulated micro-sphere “pockets” utilizing specific microsphere diameters to aid in cell reinforcement, and having distinct face-sheet layers protecting the core insert with specific MMC type and thickness, is neither taught nor suggested in the prior art. Further, utilizing a percentage of encapsulated micro-sphere “pockets” in combination with other materials in a monolithic structure comprised of a sandwich of materials of highly dissimilar material, is neither taught nor suggested in the prior art.

### SUMMARY OF THE INVENTION

A structural insert according to the present invention can be utilized in a Metal Matrix Composite (MMC) structure such as an armor structure having one or more material layers with each material layer having at least one structural insert arranged along a common surface.

A portion of at least one structural insert up to and including the entire insert may contain a cellular structure. The cellular structure can be placed in a variety of locations throughout the insert in combination with other material types to achieve desired shear strength, bend strength, stiffness, and energy absorption where needed.

The cellular structure may also contain filler materials inserted in the cells. The cellular structure enables locating the filler material in specific locations and acts as a “holder” for the filler materials. The insert may comprise in combination with the cellular structure dense or porous material types arranged in the insert.

The insert is infiltrated with a liquid metal which solidifies within the inserts open porosity. A reinforcement material containing a fraction of high volume hollow microspheres with interior voids can be utilized and placed within the inserts cellular structure to decrease the weight of the armor system. Subsequent to metal infiltration, the metal encapsulates the micro-spheres within the cells of the cellular structure, forming pockets of micro-spheres therein. These encapsulated hollow microspheres comprise a ceramic or glass wall around an interior void having a wall thickness that reinforces the void wall surface. The encapsulating metal further bonds to the walls of the cellular structure increasing the crush strength of the cell wall.

The inserts may include an infinite combination of dense material and porous material types and geometries. These dense materials may comprise inorganic material systems such as ceramics, metals or composites with dense microstructures.

The structural inserts of the present invention can be used as a component in the material layers of a Metal Matrix Composite Armor System and may be included in one or more material layers. A typical armor system may include multiple material components arranged in a common plane and stacked upon each other. The material components can include, in addition to the structural inserts of the present invention, inserts made of dense and porous material types, such as dense ceramic tiles or porous ceramic fillers. A layer of hollow microspheres as a material layer is also contemplated.

The material layers are infiltrated with liquid metal which solidifies within the materials open porosity thereby binding the layers together to create a coherent integral structure. The selection of different dense and porous material types allows the designer to vary physical and mechanical properties throughout the structure for optimization and increased effectiveness of the armor system. The selection of different material types may be based on strength, toughness, stiffness, interface bonding, thermal expansion and weight attributes of the individual material types desirable for blast energy absorption.

The liquid metal is introduced under pressure into the casting mold encapsulating and infiltrating the material layers, and encapsulating around the hollow microspheres contained in the cells of the cellular structure, and within the reinforcements of the face sheet layers, whether fibrous or hollow or solid particulate. The mold chamber is fabricated to create the final shape or closely approximate that desired of the final product.

In one embodiment, having the entire cellular structure filled with micro-spheres, the combination of micro sphere diameter, face-sheet type and thickness, and core thickness, combined with the increased bonding effect of the encapsulated spheres to the cell walls, has demonstrated superior energy absorption characteristics.

### BRIEF DESCRIPTION OF THE DRAWINGS

The invention is best understood from the following detailed description when read in connection with the accompanying drawings, which illustrate various embodiments of the present invention:

FIG. 1 is a perspective view of a Honeycomb material utilized in the structural insert of the present invention.

FIG. 2 illustrates that structural insert 25 can be configured as part of a multi-layer metal matrix composite armor system having multiple inserts 25 placed side by side and stacked upon each other.

FIG. 3 and FIG. 4 illustrate a structural insert 25 with alternative placement of honeycomb material 10 and filler material 20 prior to metal infiltration.

FIG. 5 illustrates a structural insert 25 utilizing a honeycomb material 10 with a portion of openings 10A filled with a filler material 20 and with hollow micro-spheres 30, prior to metal infiltration.

FIG. 6 illustrates the structural insert 25 of FIG. 5 further including metal inserts 35 placed within honeycomb material 10 prior to metal infiltration.

FIG. 7 illustrates the structural insert 25 of FIG. 6 subsequent to metal infiltration casting.

FIG. 8 illustrates a top view of the structural insert 25 of FIG. 6 arranged in a Metal Matrix Composite Armor subsequent to metal infiltration casting.

FIG. 9 illustrates a cross-section of the structural insert 25 of FIG. 6 having top and bottom facesheets 45 subsequent to metal infiltration casting.

FIG. 10 illustrates a cross-section of the structural insert 25 having facesheets 45 of FIG. 9, and further including a dense ceramic layer 50.

FIG. 11 is a top view of a honeycomb cell filled with cenospheres and subsequent to metal pressure infiltration.

FIG. 12 is a cross sectional view of the cell of FIG. 11.

### DETAILED DESCRIPTION OF THE INVENTION

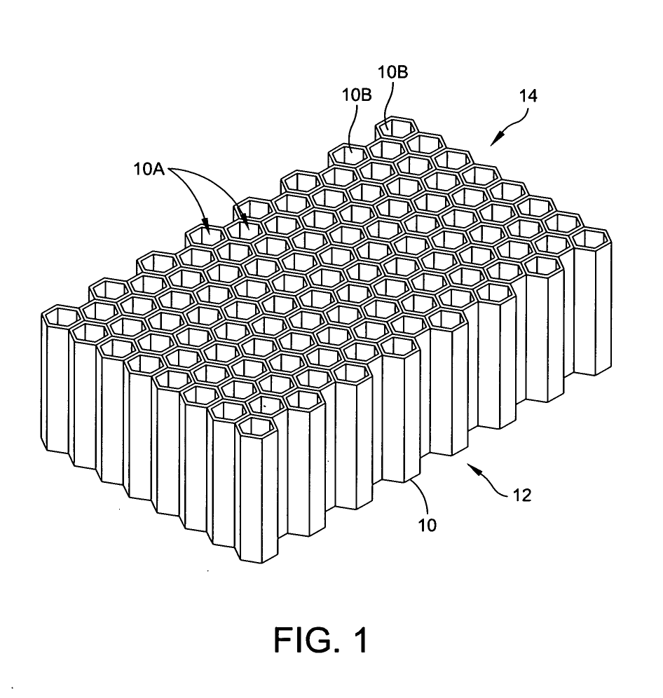

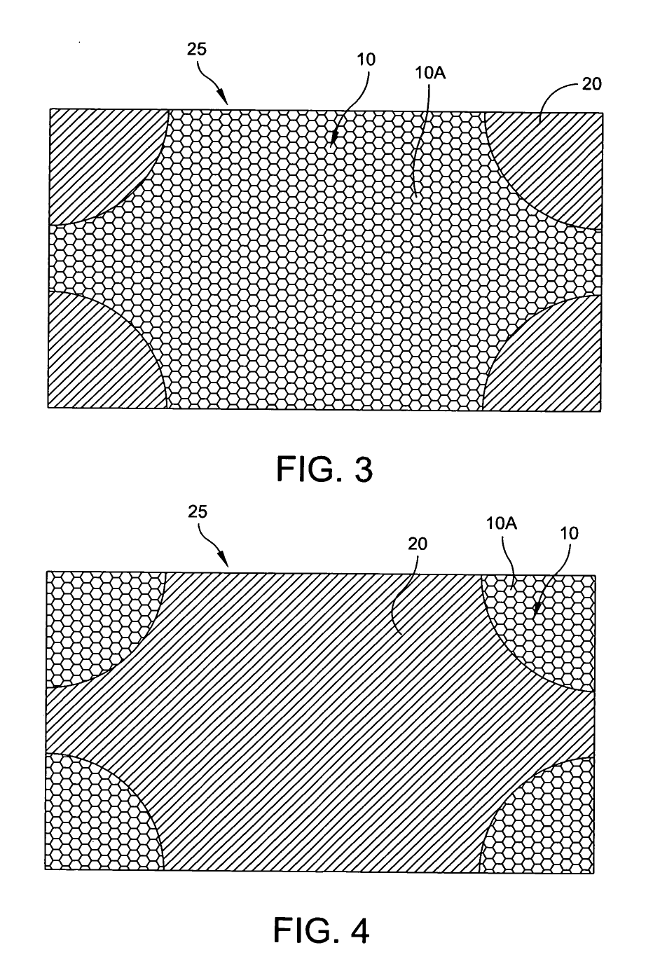

A structural insert for a Metal Matrix Composite (MMC) Armor having a polygonal or HoneyComb Core, according to the present invention, is best seen in the embodiments illustrated in FIGS. 3-10. Referring to FIG. 1, a honeycomb core or cellular structure 10 is disclosed with openings 10A having interior walls 10B and oppositely facing sides 12 and 14 between which the openings 10A extend. In the disclosed embodiment, the openings 10A are of hexagonal form, having six interior walls 10B, but may take on any cellular structure.

The honeycomb core 10 may be made from either ceramic or metal and is placed in a sealed mold cavity prior to metal infiltration casting. Suitable metal infiltrants include but are not limited to aluminum alloys, copper, titanium and magnesium, and other metal alloys cast from the molten liquid phase. The liquid metal infiltration process is described in U.S. Pat. No. 3,547,180 and incorporated herein by reference for all that it discloses.

FIG. 3 illustrates honeycomb core 10 as part of a structural insert 25 prior to metal infiltration. Insert 25 includes filler material 20 replacing a portion of honeycomb core 10 at the edges of the insert 25. FIG. 4 illustrates an alternative embodiment where honeycomb core 10 replaces a portion of filler material 20 at the edges of insert 25. It is contemplated that any combination of filler material 20 and honeycomb core 10 may be utilized in an insert 25 to provide different characteristics such as increased shear strength at the edges of insert 25 or blast force absorption and deflection of an attendant stress wave.

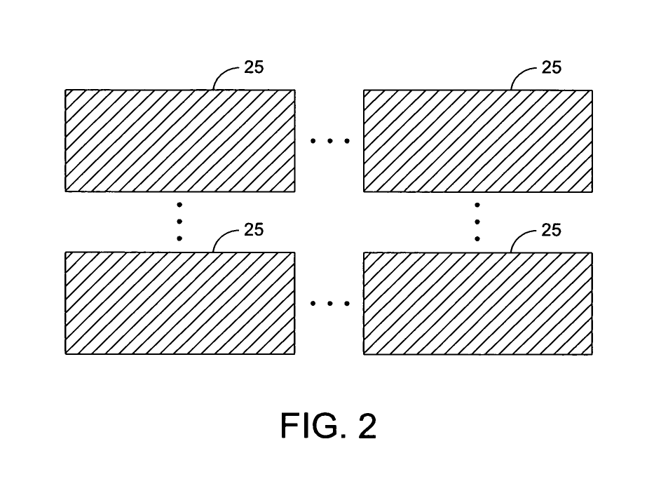

It is further contemplated that the inserts may be utilized in an armor structure having one or more stacked material layers and each material layer having at least one reinforcement insert arranged along a common surface, as illustrated in FIG. 2.

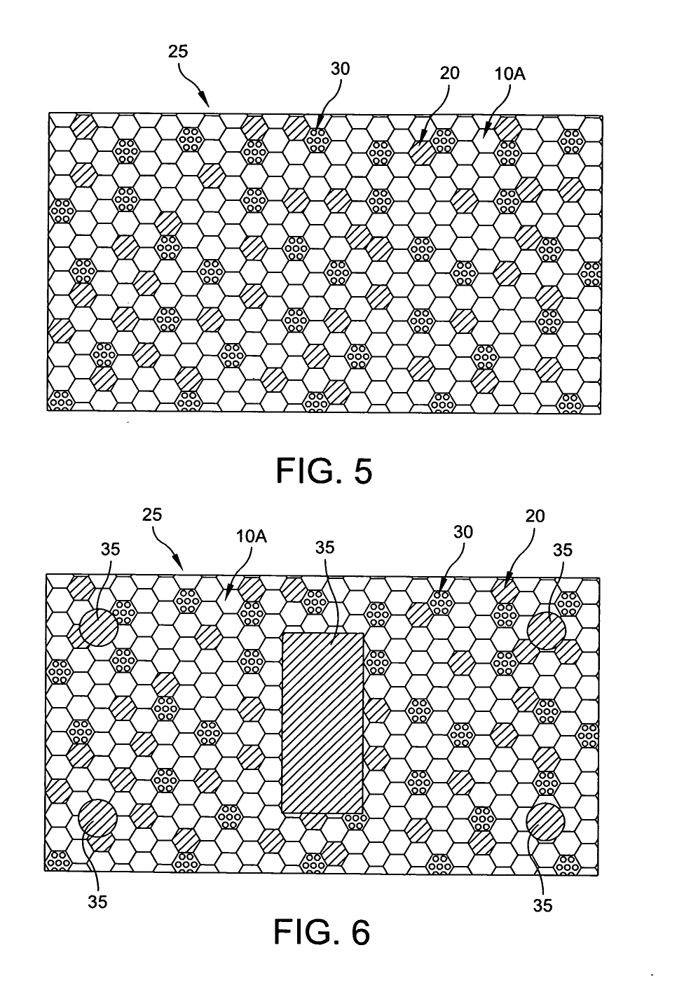

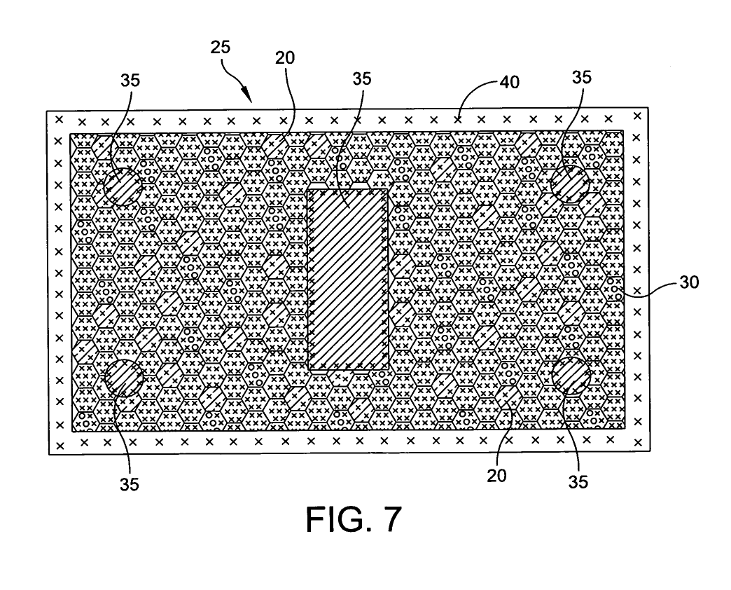

An insert 25 having a honeycomb core 10 is illustrated in FIG. 5 and FIG. 6 prior to metal infiltration. In FIG. 5, a portion of openings 10A are filled with a filler material 20 and with hollow micro-spheres 30 and the remaining openings 10A are open. In FIG. 6, an additional filler material comprising a metal insert 35 replaces a portion of honeycomb core 10 prior to metal infiltration. The metal insert can be machined to provide an attachment means for the insert 25. FIG. 7 illustrates the insert 25 of FIG. 6 subsequent to metal infiltration casting.

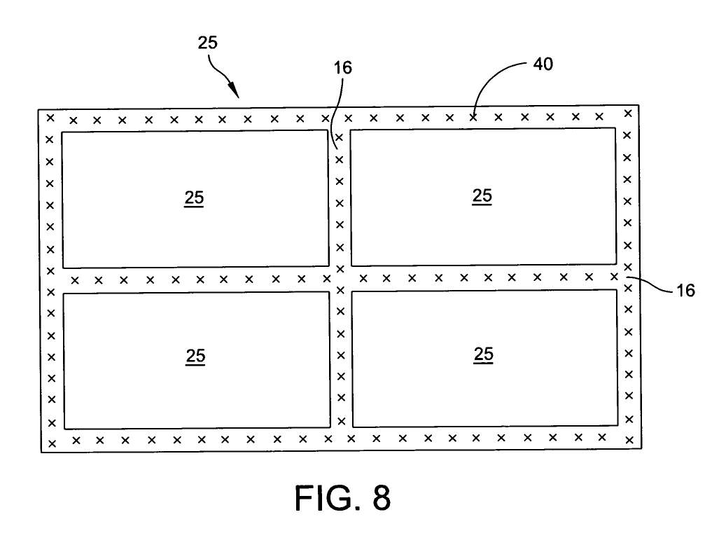

FIG. 8 illustrates the arrangement of four inserts 25 after placement in a mold cavity and subsequent to metal infiltration casting. As illustrated in FIG. 7, the metal “XX” infiltrates all areas of open porosity, including areas around the cenospheres 30. In one embodiment, and to reduce the density of the armor layer, high volume fractions of hollow micro-spheres 30 with interior voids, are used to fill openings 10A. The bubble material 30 comprises a lightweight, inert hollow spheres filled with air and/or gas with a density about 0.4 to 1.6 grams/cubic-centimeter. The hollow spheres 30 are denoted by “ooo” and the metal infiltrant denoted by “XXX” in FIGS. 7-9 after metal infiltration. Bubble material 30 is dispersed randomly throughout openings 10A as illustrated in FIG. 5, but may also be used exclusively to fill openings 10A.

The hollow spheres are hermetic, and most do not collapse or fill with metal during the metal infiltration process. The hollow spheres have been demonstrated by the inventor to be strong enough to withstand the pressure of metal infiltration casting and will not soften or crush under extreme metal infiltration temperatures greater than 600 degrees celsius. Furthermore, the hollow spheres do not degrade or dissolve due to chemical reactions with the metal infiltrant.

In the disclosed embodiment, hollow spheres of the Cenosphere variety are utilized as the hollow micro-sphere material 30. However, any ceramic or metallic bubble which is hermetic with the metal infiltrant, has sufficient crush strength, and acceptable reactivity with the infiltrant is acceptable. Cenospheres, a component of aluminum fly-ash, have shown to exhibit light weight, and when used in Metal Matrix Composite (MMC) structures can reduce density to less than 2 g/cc.

Cenospheres are produced as a natural by-product of coal combustion during the generation of electric power. As a portion of the fly-ash generated in coal production, cenospheres are recycled from the waste stream. They are made up of inert silica, iron and alumina, and have a size ranging from 1 to 5 mm with an average compressive strength of 3000 PSI. Cenospheres of low bulk density are produced by Sphere Services, Inc, of Oakridge, Tenn.

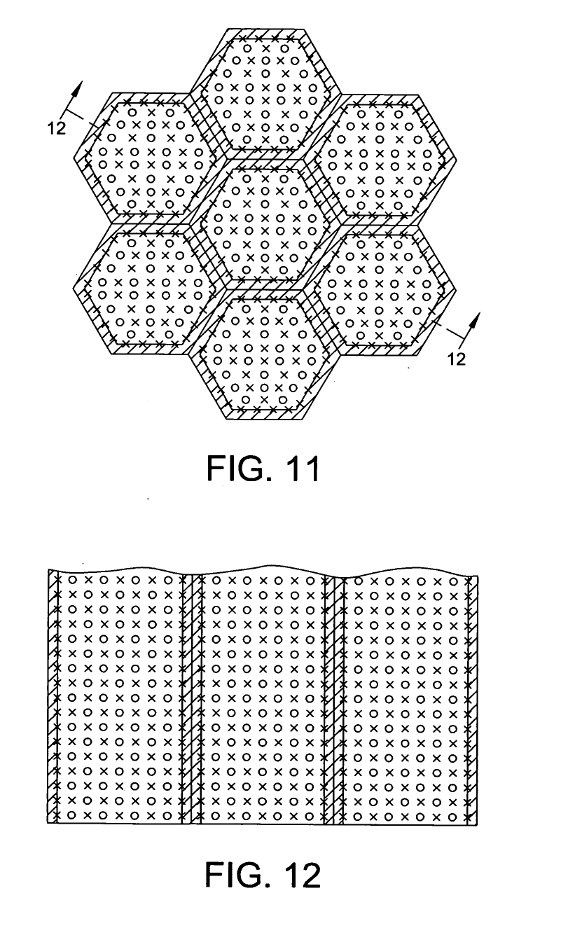

In the preferred embodiment, the cenospheres of the present invention have a mean diameter of less than 100 microns. Referring to FIGS. 11 and 12, the infiltrant penetrates between and around the cenospheres 30, forming an encapsulating barrier 32, while providing a compressive force packing the cenospheres 30 together. The bonding of barrier 32 to cell wall 10B enhances the rigidity of the cell. These enhanced honeycomb cell structures makes each cell more impervious to buckling after a blast wave impact.

It is understood that an entire honeycomb insert filled with cenospheres, after infiltration pressure casting, creates a structure better capable of absorbing energy after a blast impact. FIG. 12 illustrates a cross section of a typical cell illustrating the infiltrant bond that creates an encapsulating barrier 32 throughout the depth of the cell interior 10A.

As illustrated in FIG. 7, metal “XX” further infiltrates openings 10A infiltrating areas of open porosity in filler material 20 creating a metal matrix composite (MMC) within the filler material 20 and bonding filler material 20 to interior walls 10B. Since metal inserts 35 contain no open porosity the metal “XX” infiltrates only at the surface.

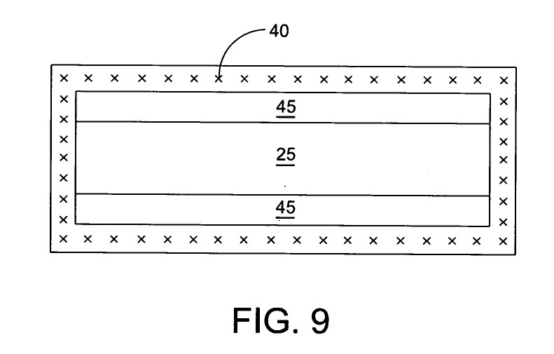

As illustrated in FIGS. 7-9, subsequent to metal infiltration casting, a metal enveloping layer 40 is formed around the metal infiltrated insert(s) 25. FIG. 8 illustrates a top view of the side by side placement of inserts 25, and may include an inner seam 16 there-between, and metal infiltrated around and in between the inserts 25 (within seam 16), to facilitate the bonding together of a plurality of inserts 25. As illustrated in the FIG. 9 cross-section, top and bottom face sheets 45 comprising a filler material 20 of metal composite or metal matrix material, being dense or porous, may be placed around insert 25 to create a structural sandwich panel having facesheets 45 to provide strength and stiffness in bending.

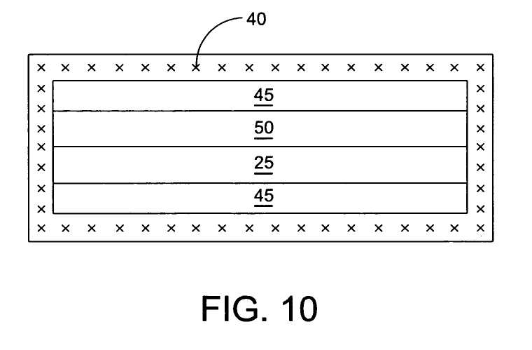

The facesheets 45 can range in thickness from about 0.5 mm to the full thickness of honeycomb cellular structure 10, as measured by the distance between oppositely facing sides 12 and 14. FIG. 10 illustrates the insert of FIG. 9, further including a dense ceramic layer 50 and face sheets 45. The filler material 20 can be of a variety of dense or porous material types, either in combination, or a single filler material 20 or micro-spheres 30 utilized throughout the cellular structure 10.

In one embodiment, the cellular structure 10 is filled entirely with micro-spheres 30, the microspheres 30 have a mean diameter of less than 100 microns, the honeycomb cellular structure 10 is at least 10 times the thickness of facesheets 45, facesheets 45 are at least 0.5 mm thick, and the facesheets are aluminum with between 3 and 60 percent ceramic fiber content.

This combination, when combined in a single cellular structure 10, of insert 25, after metal infiltration and formation of a metal matrix composite (MMC), when in compression and subjected to high rate loading of 1000/sec, exhibited a plateau stress between 100 MPa and 300 MPa and sustained greater than 20 percent strain.

Dense material types may include surface voids that are filled with aluminum during the Al infiltration process such as metal inserts 35 as illustrated in FIG. 6. Mechanical and chemical reactive surface bonding allows the dense material metal infiltrated surface to bond to adjacent material types during metal infiltration casting.

The compression and containment provided in a Metal Matrix Composite Armor comprised of inserts 25 having a honeycomb core 10 functions to attenuate a blast from an explosive by deforming in response to the blast shock. These differing material properties tend to absorb or attenuate the shock wave more effectively than is generally possible with a material that has uniform material properties throughout. Utilizing materials of different CTE values and which are strongly bound both mechanically and chemically produces compressive and tensioned layers throughout the composite armor after metal infiltration and solidification.

Porous material types include reinforcement of ceramic or metal in the form of particulates or fibers. The ceramic and/or metal particulate or fiber reinforcement include materials such as aluminum oxide, carbon, graphite, silicon carbide, boron carbide, titanium, tungsten, molybdenum, copper, aluminum and other anticipated ceramics or metal materials. The porous material types have an interior open porosity between about 30% and about 98% prior to metal infiltration and have a predetermined fraction of void volume or open structure throughout the material structure, or can be open spaces in a closed mold, such as honeycomb core 10 openings 10A, that are filled with molten metal subsequent to metal infiltration casting. Porous materials can also be hollow spheres, whether ceramic or metal, containing void space within. Void space within such materials can be a single contiguous void, or comprised of many small voids.

A process of forming a porous material or preform constituent, which may be utilized in subject invention, is disclosed in U.S. Pat. No. 5,047,182, incorporated herein by reference for all it discloses. A filler material type 20 of porous material can be utilized as described herein as part of insert 25 (FIG. 3, 4) and can also be used to fill openings 10A of honeycomb core 10 (FIG. 5,6). Furthermore a porous material can be utilized as a facesheet 45 as illustrated in FIG. 9.

Filler material 20 of dense ceramic material types includes aluminum oxide, silicon carbide, boron carbide, silicon nitride, and chemical vapor deposit diamond. Dense materials may be a dense metal such as titanium, tungsten, molybdenum, and depleted uranium. Other suitable dense materials include but are not limited to glass-ceramics, and other inorganic material systems which are compatible with molten metal processing and which can contribute to ballistic resistance of the integrated system.

Dense materials such as high strength steels, metal alloys, and ceramic alloys may be used in subject invention. A filler material type 20 of dense material can be utilized as described herein as part of insert 25 (FIG. 3, 4) and can also be used to fill openings 10A of honeycomb core 10 (FIG. 5, 6). Furthermore a dense material can be utilized as a facesheet 45 or layer 50 as illustrated in FIG. 9 and FIG. 10 or as inserts 35 as illustrated in FIG. 6 and FIG. 7.

Following infiltration casting the insert(s) 25 becomes metal rich in its open porosity at its surface (in the case of a dense material type) and throughout its open porosity in the case of porous material type.

The insert(s) 25 as illustrated in FIGS. 3-6 are initially placed into a mold cavity suitable for molten metal infiltration casting. The mold cavity is typically prepared from a die suitable for molten metal infiltration casting with the dimensions defined to produce a multi-structure metal matrix composite. The final products, as illustrated in alternative embodiments 7-10, are infiltrated with molten aluminum to form a metal matrix bonded composite in the desired product shape geometry. At this point the insert 25 (and additional facesheets for FIG. 9 embodiment, and additional dense layer for FIG. 10 embodiment) now becomes metal rich and can alternatively be referred to as a “Metal Matrix Composite”.

It should be understood that the preceding is merely a detailed description of one embodiment of this invention and that numerous changes to the disclosed embodiment can be made in accordance with the disclosure herein without departing from the spirit or scope of the invention. Rather, the scope of the invention is to be determined only by the appended claims and their equivalents.

We claim:

1. A structural insert for a composite armor, comprising:
a top and bottom facesheet reinforcement layer, said top and bottom facesheet having a thickness of at least 0.5 mm, and further comprising aluminum and ceramic fiber wherein said ceramic fiber is between 3 and 60 percent volume;
at least one cellular structure arranged in a common plane, said cellular structure further arranged in one or more stacked layers, said cellular structure disposed between said top and bottom facesheet, said cellular structure having a plurality of interior openings and an external surface, said plurality of interior opening having oppositely faced sides between which said plurality of openings extend, said cellular structure being at least 10 times the thickness of one of said said top and bottom facesheets;
a first filler material placed within said plurality of openings of said at least one cellular structure to provide crush absorption within said cellular structure, wherein said first filler material comprises a plurality of high volume hollow microspheres with a mean diameter of less than 100 microns; and
a metallic material infiltrating said plurality of interior openings of said cellular structure, said metallic material bonding to said plurality of microspheres and forming an encapsulating containment wall around said first filler material in each of said plurality of openings, said containment wall having an external surface bonding to said oppositely faced sides between which said plurality of openings extend, said metallic material extending outward to encapsulate said cellular structure and said top and bottom face sheets, said metallic material forming an encapsulating barrier.

2. A structural insert for a composite armor as in claim 1, wherein said structural insert when in compression and subjected to high rate loading of 1000/sec, exhibited a plateau stress between 100 MPa and 300 MPa and sustained greater than 20 percent strain.

3. A structural insert for a composite armor as in claim 1, wherein said plurality of high volume hollow microspheres have a mean diameter between about 1 and about 5 mm.

4. A structural insert for a composite armor, comprising:
a top and bottom facesheet reinforcement layer, said top and bottom facesheet having a thickness of at least 0.5 mm, and further comprising aluminum and ceramic fiber wherein said ceramic fiber is between 3 and 60 percent volume;
at least one cellular structure arranged in a common plane, said cellular structure further arranged in one or more stacked layers, said cellular structure disposed between said top and bottom facesheet, said cellular structure having a plurality of interior openings and an external surface, said plurality of interior opening having oppositely faced sides between which said plurality of openings extend;
a first filler material placed within at least one of said plurality of openings of said at least one cellular structure to provide targeted crush absorption within said cellular structure, wherein said first filler material comprises a plurality of high volume hollow microspheres with a mean diameter of between about 1 and about 5 mm; and
a metallic material infiltrating said plurality of interior openings of said cellular structure, said metallic material bonding to said plurality of microspheres and forming an encapsulating containment wall around said first filler material in each of said plurality of openings, said containment wall having an external surface bonding to said oppositely faced sides between which said plurality of openings extend, said metallic material extending outward to encapsulate said cellular structure and said top and bottom face sheets, said metallic material forming an encapsulating barrier.

5. A structural insert for a composite armor as in claim 4, wherein said cellular structure has a thickness equal to the thickness of one of said top and bottom facesheets.

6. A structural insert for a composite armor as in claim 4, further comprising a second filler material disposed in at least one of said plurality of openings, wherein said second filler material to provide targeted crush absorption within said cellular structure, said infiltrant bonding to said second filler material and said cellular structure, said first filler material and said second filler material in different openings.

7. A structural insert for a composite armor as in claim 4, further comprising a second filler material disposed in at least one of said plurality of openings, wherein said second filler material to provide targeted crush absorption within said cellular structure, said infiltrant bonding to said second filler material and said cellular structure, said first filler material and said second filler material in the same openings.

8. A structural insert for a composite armor as in claim 4, further comprising a second filler material, said second filler material replacing a portion of said plurality of openings of said cellular structure, wherein said second filler material is porous, said porous material further comprising a metal infiltrated therein.

9. A structural insert for a composite armor as in claim 4, further comprising a second filler material, said second filler material replacing a portion of said plurality of openings of said cellular structure, wherein said second filler material is a dense material, said infiltrant bonding to said second filler material and said cellular structure.

10. A structural insert for a composite armor as in claim 4, wherein said one or more stacked layers further comprise one or more dense materials disposed between said one or more stacked layers.

11. A structural insert as in claim 4, further comprising a dense material layer, said dense material layer disposed between said first and second face sheets.

12. A structural insert as in claim 4, wherein said first and second face sheet thickness precludes said cellular structure from bending.

13. A structural insert as in claim 4, wherein said metal infiltrant is selected from the group consisting of aluminum alloys, copper, titanium, and magnesium.

14. A structural insert for a composite armor as in claim 4, wherein a plurality of said cellular structures arranged in a common plane have an inner seam therebetween, said metallic material infiltrating said inner seam between each of said plurality of cellular structures, said inner seam metallic material bonding said adjacent cellular structures together.

15. A structural insert for a composite armor as in claim 1, wherein a plurality of said cellular structures arranged in a common plane have an inner seam therebetween, said metallic material infiltrating said inner seam between each of said plurality of cellular structures, said inner seam metallic material bonding said adjacent cellular structures together.

16. A structural insert for a composite armor as in claim 14, wherein said inner seam between said plurality of cellular structures further includes said infiltrated metallic material.

17. A structural insert for a composite armor as in claim 15, wherein said inner seam between said plurality of cellular structures further includes said infiltrated metallic material.

18. A structural insert for a composite armor as in claim 4, wherein said cenospheres content is about 50% of said metal encapsulated cellular structure.

19. A structural insert for a composite armor, comprising:
a top and bottom facesheet reinforcement layer, said top and bottom facesheet having a thickness of at least 0.5 mm, and further comprising aluminum and ceramic fiber wherein said ceramic fiber is between 3 and 60 percent volume;
a plurality of cellular structures arranged in a common plane, said cellular structures having an inner seam between each of said plurality of cellular structures, said cellular structures further arranged in one or more stacked layers, said cellular structures disposed between said top and bottom facesheets, said cellular structure having a plurality of interior openings and an external surface, said plurality of interior opening having oppositely faced sides between which said plurality of openings extend, said cellular structure being at least 10 times the thickness of one of said said top and bottom facesheets;
a first filler material placed within said plurality of openings of said plurality of cellular structures to provide crush absorption within said cellular structure, wherein said first filler material comprises a plurality of high volume hollow microspheres with a mean diameter of less than 100 microns; and
a metallic material infiltrating said plurality of interior openings of said plurality of cellular structure and said inner seam between each of said plurality of cellular structures, said inner seam metallic material bonding said adjacent cellular structures together, said metallic material further bonding to said plurality of microspheres and forming an encapsulating containment wall around said plurality of microspheres in each of said plurality of openings, said containment wall having an external surface bonding to said oppositely faced sides between which said plurality of openings extend, said metallic material extending outward to form an encapsulating barrier around said cellular structure and said top and bottom face sheets.
